(19) United States
(12) Patent Application Publication
(10) Pub. No.: US 2005/0109331 A1
(43) Pub. Date: May 26, 2005

(54) Means for utilizing the heat source with efficiency

(76) Inventor: Hui Hsiung Chao, Yilan County (TW)

Correspondence Address: HUI HSIUNG CHAO;7F., No. 213, Civic Boulevard. Sec.4, Taipei, 105, TW

(21) Appl. No.: 10/723,193

(22) Filed: Nov. 25, 2003

(51) Int. Cl. F24B 3/00; A47J 37/00

(52) U.S. Cl. 126/25 R; 126/39 R

(57) ABSTRACT

The present invention discloses a means for utilizing the heat source with efficiency at least comprising: a container, which is settled at the center of said means; a sand, which is settled within said means and outside said container; a hot gas channel, which is interconnected with said container and is covered with said sand; a collecting casket, which is settled on the bottom of said container and is used to collect the ash of the charcoal; a casket chamber, which could allocate said collecting casket within; a storage room, which is sited below said casket chamber; a plurality of rolling wheels, which is sited on the bottom of said means that could make said means moving freely; said hot gas channel could be covered by means of the sand to avoid the heat dissipation of the heat inside the heat gas channel while keeping high temperature which could make use of the heat resource and thus achieves the effects of baking, temperature-maintenance, cover toast as well as warm-keeping on the same time.

### FIELD OF THE INVENTION

This invention relates to a kind of means of utilizing the heat source with efficiency; especially refer to a means for utilizing the heat source with efficiency of which it could proceed baking, temperature maintenance, sultry baking as well as warm maintenance.

### BACKGROUND OF THE INVENTION

The cabobs impression impressed by the common people is nothing but to pile up a few stones or bricks to build-up a kitchen stove, to put the charcoal inside said kitchen stove and to firing, next to erect the net of cabobs on the kitchen stove, which makes the cabobs meat or food and eatable; however, said kind of cabobs belongs to the oldest primary way, and the cabobs food by such kind of method is easily to cause the boil dry of the food since the fire is uncontrollable; when the meat is roasted, we usually subdivides the foods of roast and un-roast into two dishes and place them on, however, since there is a distance between the chair or table of cabobs and the kitchen stove, so the food taking is very inconvenient for taking the food on cabobs.

Besides, the Bar-B-Q shop commonly popular in the market is widely accepted and liked by the people who consumes since their way of eating is novel and delicious, however, if the consumers often goes to said kind of Bar-B-Q shop to have their lunch or dinner, it will also cause a burden in economic with its non-cheap price.

Besides, there is a cabobs table on the market now, please refer to FIG. 11, which is the cross-sectional view of the conventional cabobs table, as shown in the figure:

There forms a round shaped kitchen stove hole at the center portion of said cabobs table 7, which could put the heat-isolation pot 72 which puts the cabobs oven 73 inside, and the cabobs table 7 was supported by a plurality of table leg 75 in contact with the earth, and on the top portion of said heat-isolation pot 72 there settles an upper cap 71 which could prevent the wind sand to pollute the food, whereas on the top of said cabobs oven 73 there settles a cabobs rack 74 for foods settlement for baking. The users could thus enjoy their Bar-B-Q's conveniently not only without going to the Bar-B-Q's shops through such design but also avoid the burning of the users by the design of the heat-isolation pot, which is practicable, however, such structure has the following disadvantages:

1. The heat source of cabobs could not be re-utilized: Though the design by the heat-isolation pot avoids the possibility of burning hurt of the users, it could not make use of the heat energy dissipated for the usage of other means; for example, when you want to bake the sweet potatoes or other foods on the same time of cabobs, or you wish to maintain the temperature of the drink-for-keeping-warm, you have to take another heat source, which leads to the waste of the resources.

2. There is too little usage of the cabobs table: Said design of the cabobs table could only have the effect of Bar-B-Q and soup boiling; however, for the baking of large foods such as chicken toast, duck toast, etc, it could not make use.

3. The cabobs table is unable to move freely: If the user want to use it by changing the place he or she is in usage or change an angle of usage, it is needed for he or she to clean-up all the commodities on the cabobs table first and to proceed the position changing, otherwise it is liable for him or her to makes the objects on the cabobs table dropping to the earth, which is very inconvenient.

Due to the drawbacks of the conventional cabobs table, the inventor makes his (her) efforts trying to overcome the difficulties and problems faced according to his (her) many experiences in industries and further research a kind of means of utilizing the heat sources efficiently which achieves the effects of proceeding baking, temperature maintain, cover burning, as well as warm keeping.

### SUMMARY OF THE INVENTION

Thus, the main object of this invention is to provide a means of utilizing the heat source with efficiency which could precede other cover burning of foods on the same time of Bar-B-Q.

Another object of this invention is to provide a means of utilizing the heat source with efficiency which could maintain the temperature of the warm-keeping drinks on the same time of cabobs.

Another object of this invention is to provide a means of utilizing the heat source with efficiency which is convenient for the users to take warm on the same time of cabobs.

Still another object of this invention is to provide a means of utilizing the heat source with efficiency which could move the position on the same time of cabobs.

To achieve the above-mentioned object of invention, the means of utilizing the heat source with efficiency according to this invention at least comprises: a container, which is settled at the center of said means; a sand, which is settled inside said means and outside said container; a heat-gas channel, which is interconnected with said container and covered with said sand; a collecting casket, which is settled on the bottom of said container and is used to collect the ash of the charcoal; a casket manger, which could allocate said collecting casket inside; a storage room, which is sited below said casket manger; a plurality of rolling wheel, which is settled on the bottom of said means, which makes said means moving freely. Said heat gas channel is covered through said sand, which could avoid the dissipation of the heat inside said heat channel and keeps high temperature, thus the heat energy could be utilized with efficiency, which achieves the effect of baking, toasting, temperature maintenance, as well as warm maintenance proceeded on the same time.

### BRIEF DESCRIPTION OF THE DRAWINGS

FIG. 1 is a structure decomposition figure of the means of utilizing the heat source efficiently of this invention;

FIG. 2 is a decomposition illustrative figure of the preferred embodiment of the means of utilizing the heat source efficiently of this invention;

FIG. 3 is an assembly illustrative figure of the preferred embodiment of the means of utilizing the heat source efficiently of this invention;

FIG. 4 is a lateral cross-sectional view of the preferred embodiment of the means of utilizing the heat source efficiently of this invention;

FIG. 5 is a lateral cross-sectional view of one preferred embodiment of the means of utilizing the heat source efficiently of this invention;

FIG. 6 is a lateral cross-sectional view of another preferred embodiment of the means of utilizing the heat source efficiently of this invention;

FIG. 7 is a lateral cross-sectional view of still another preferred embodiment of the means of utilizing the heat source efficiently of this invention;

FIG. 8 is a lateral cross-sectional view of still another preferred embodiment of the means of utilizing the heat source efficiently of this invention;

FIG. 9 is a structure decomposition figure of another preferred embodiment of the means of utilizing the heat source efficiently of this invention;

FIG. 10 is a lateral cross-sectional view of still another preferred embodiment of the means of utilizing the heat source efficiently of this invention;

FIG. 11 is a lateral cross-sectional view of the conventional cabobs table.

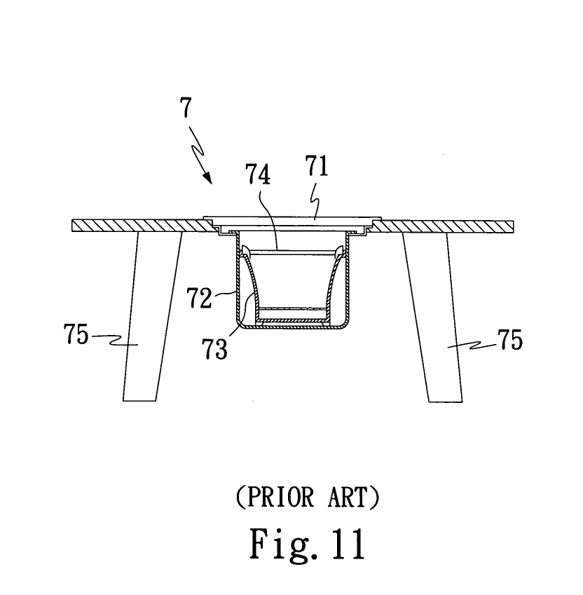

### DETAILED DESCRIPTION OF THE PREFERRED EMBODIMENTS

In order to make the auditors fully understand the object, character, as well as effect of this invention, this invention is detail illustrated by the following embodiment in accompany with the appendix drawings and explained as follows:

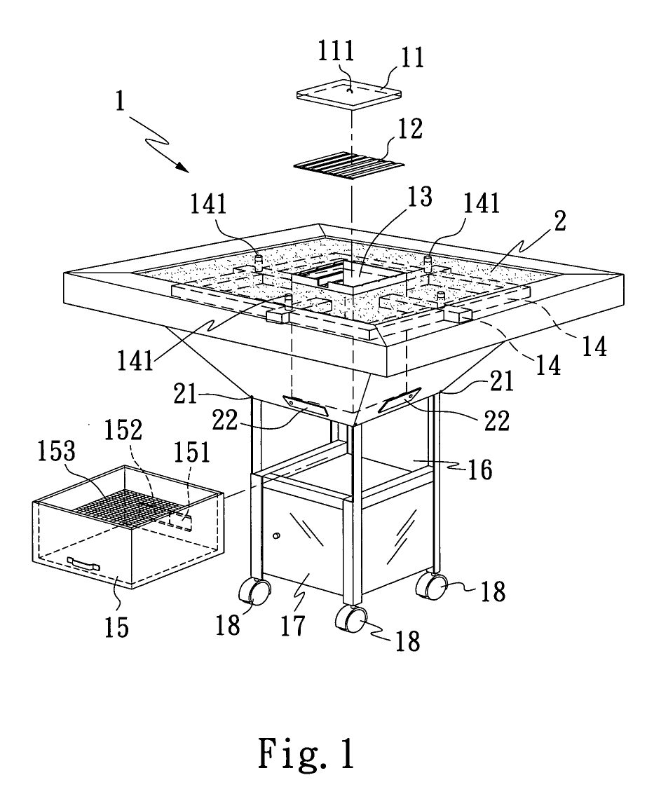

Please refer to FIG. 1, which is the structure decomposition view of the means of utilizing the heat source with efficiency of this invention, as shown in the Figure:

The means of utilizing the heat source with efficiency 1 of this invention comprises at least: a container 13, which is settled at the center of said means 1, there settles a supporting plate 12 and an upper cap 11 inside said container 13 and on the top of said container 13, on the top facet of said upper cap 11 there settles an ear 111; a sand 2, which is settled inside said means 1 and outside said container 13, and there settles a plurality of drain pore 21 and a plurality of sand-leaking vent 22 on the neighboring of said sand 2 and the portion where it contacts said means 1, if they were settled outdoors, the rain water falling on the sand 2 on the rainy day could be drain out through said drain pore 21, keep the dry of the sand 2; if the sand 2 is pullulated and requires to renew it, the sand-leaking vent 22 could be opened so that the sand 2 will expel out naturally, and the new sand 2 will be replaced; a heat gas channel 14 which is interconnected with said container 13 and covered with said sand 2, and there connects and settles a plurality of empty site 141 above such heat gas channel 14; a collecting casket 15 which is settled on the bottom of said container 13, there settles an air ventilate vent 151 on the end of the rear wall, and there settles a collecting casket 15 on said air ventilate vent 151 which could be adjusted the quantity of ventilation to control the amounts of fire of the charcoal; besides, there settles a iron net 153 inside said collecting casket 15; a casket chamber 16 which I settled on the bottom of the container 13, where it could allocate said collecting casket 15; a storage chamber 17, which is sited below said casket chamber 16, which could allocate some cabobs commodities within; a plurality of rolling wheels, which is settled on the bottom of said device 1, which makes said device moving freely. Besides, the design of said sand 2 could be used as the fire-fighting sand on fire, which provides the effect of fire-excortication.

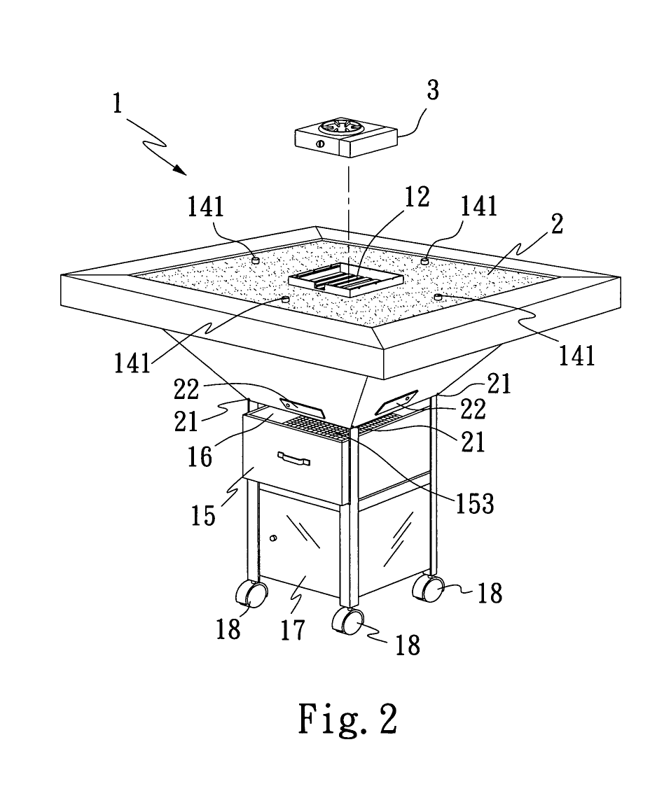

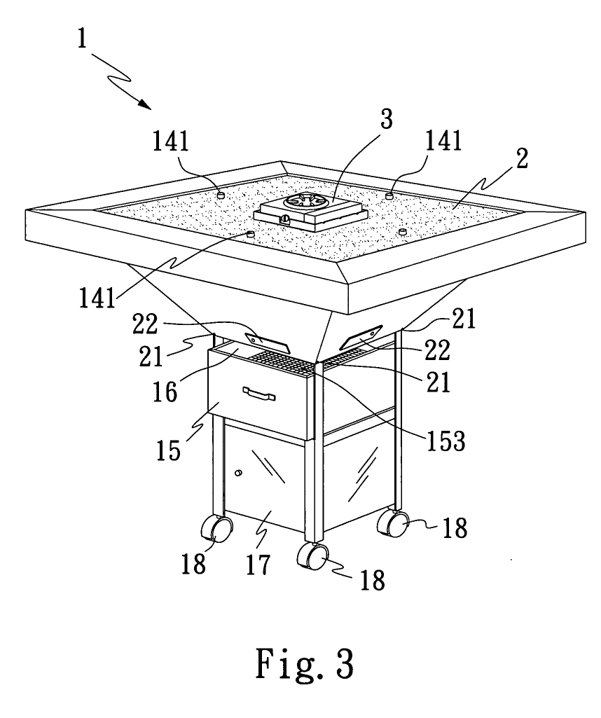

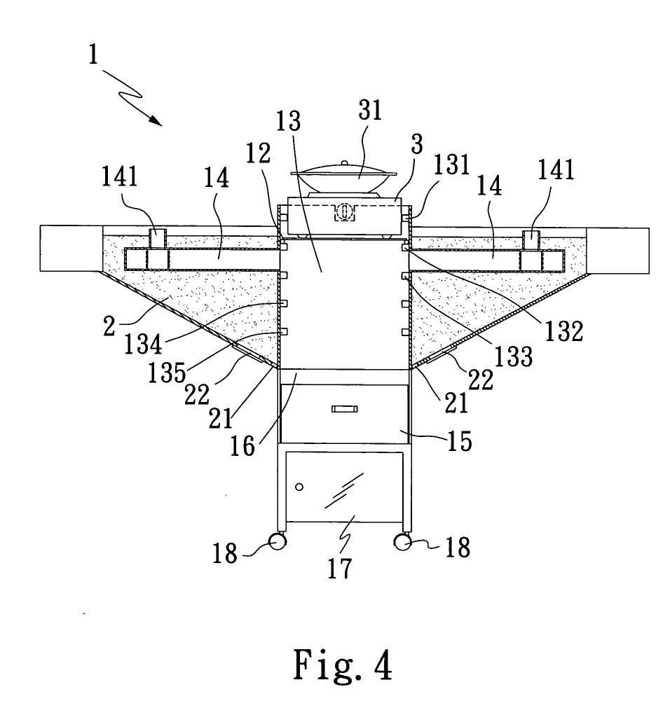

Please refer to FIG. 2 and FIG. 3, which is the decomposition illustrative figure of the embodiment of the means of utilizing the heat source according to this invention and the assembly illustrative figure of the embodiment of the means of utilizing the heat source according to this invention, respectively; next please refer to FIG. 4, which is the cross-sectional view of the preferred example of the means of utilizing the heat source according to this invention, as shown in the figure:

Said means of utilizing the heat source with efficiency 1 at least comprises: a container 13, which is settled at the center of said means 1, there settles a first convex rib 131, a second convex rib 132, a third convex rib 133, a fourth convex rib 134, and a fifth convex rib 135 inside said container 13, and place a supporting plate 12 above said second convex rib 132; a sand 2, which is settled inside said means 1 and outside said container 13, and there settles a plurality of drain pore 21 and a plurality of sand-leaking vent 22 on the neighboring of the sand 2 and on the contacting portion of said means 1, if they were placed outdoors, the rainwater falling on the sand 2 at rainy day will be drained out through said drain pore 21 which keeps the dry of sand 2, if the sand 2 is polluted and requires to be replaced with a new one, said sand-leaking vent 2 could be opened to drain out the sand 2 naturally, next to replace the new sand 2; a hot gas channel 14, which is interconnected with said container 13 and is covered with said sand 2, and there connects and settles a plurality of empty site 141 above said hot gas channel 14; a collecting casket 15, which is settled within the casket chamber 16 on the bottom of said container 13; a storage chamber 17, which is sited below said casket chamber 16 and could allocate some cabobs commodities within; a plurality of rolling wheels 18, which is settled on the bottom of said means of utilizing the heat source with efficiency 1 and could make said means of utilizing the heat source with efficiency 1 moving freely. Besides, there places a gas oven 3 on top of the supporting plate 12, and there settled a pot means 31 above the gas oven 3, the means of utilizing the heat source with efficiency 1 of this invention could provide the function of soup boiling by means of this. If we change the above-mentioned pot means 31 into a tea pot, then the means of utilizing the heat source with efficiency 1 of this invention will have the function of tea-making.

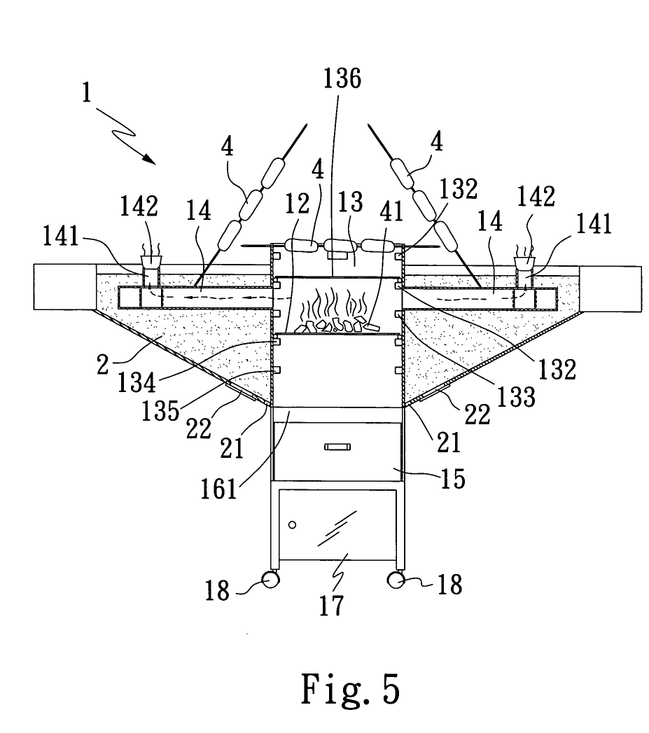

Please refer to FIG. 5, which is the cross-sectional view of one example of the means of utilizing the heat source with efficiency 1 of this invention, as illustrated in the figure:

Said means of utilizing the heat source with efficiency 1 at least comprises: a container 13, which is settled at the center of said means 1, there settles a first convex rib 131, a second convex rib 132, a third convex rib 133, a fourth convex rib 134, and a fifth convex rib 135 inside said container 13, and place a supporting plate 12 above said second convex rib 132; a sand 2, which is settled inside said means 1 and outside said container 13, and there settles a plurality of drain pore 21 and a plurality of sand-leaking vent 22 on the neighboring of the sand 2 and on the contacting portion of said means 1, if they were placed outdoors, the rainwater falling on the sand 2 at rainy day will be drained out through said drain pore 21 which keeps the dry of sand 2, if the sand 2 is polluted and requires to be replaced with a new one, said sand-leaking vent 2 could be opened to drain out the sand 2 naturally, next to replace the new sand 2; a hot gas channel 14, which is interconnected with said container 13 and is covered with said sand 2, and there connects and settles a plurality of empty site 141 above said hot gas channel 14; a collecting casket 15, which is settled within the casket chamber 16 on the bottom of said container 13 which is used to collect the ash of charcoal 41; a storage chamber 17, which is sited below said casket chamber 16 and could allocate some cabobs commodities within; a plurality of rolling wheels 18, which is settled on the bottom of said means of utilizing the heat source with efficiency 1 and could make said means of utilizing the heat source with efficiency 1 moving freely. Besides, there places a charcoal fire 41 on top of the supporting plate 12, and there bakes or toasts the food above the charcoal fire 41, which makes the means of utilizing the heat source with efficiency 1 of this invention could provide the function of cabobs, and it could avoid the raising of dust of the charcoal fire and thus pollutes the food 4. Besides, the heat gas of said charcoal fire 41 could be transported onto empty site 141 through the hot gas channel 14 which keeps warm of the warm-keeping drinks inside the hot gas channel 14. In addition, since the height of said casket chamber 16 is higher than said collecting casket 15, when said collecting casket 15 is inserted into said casket chamber 16, there forms a vacant 161 between the above portion of said collecting casket and the casket chamber 16 on bottom of the container so that part of the hot gas of the charcoal fire will be dissipated out from said vacant 161, when there is a cold weather or at winter, it is convenient for the users to warm oneself by the fire. Through this, it will makes the means of utilizing the heat source with efficiency 1 keeps the temperature of the warm-keeping drinks as well as has the effect of being convenient with the users for warm oneself by the fire at the same time of cabobs.

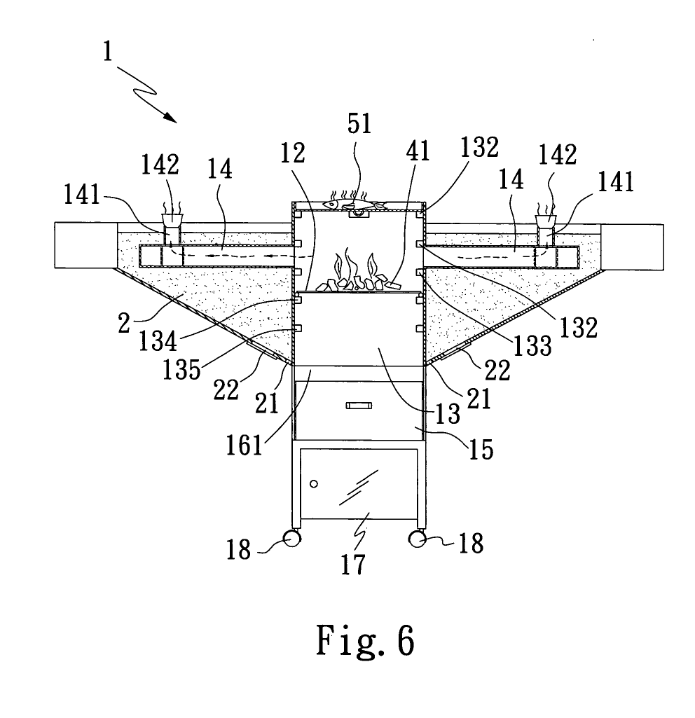

Please refer to FIG. 6, which is the cross-sectional view of another example of the means of utilizing the heat source with efficiency 1 of this invention, as illustrated in the figure:

Said means of utilizing the heat source with efficiency 1 at least comprises: a container 13, which is settled at the center of said means 1, there settles a first convex rib 131, a second convex rib 132, a third convex rib 133, a fourth convex rib 134, and a fifth convex rib 135 inside said container 13, and inversely place an upper cap 11 above said first convex rib 131, and to place a supporting plate 12 above said fourth convex rib 134; a sand 2, which is settled inside said means 1 and outside said container 13, and there settles a plurality of drain pore 21 and a plurality of sand-leaking vent 22 on the neighboring of the sand 2 and on the contacting portion of said means 1, if they were placed outdoors, the rainwater falling on the sand 2 at rainy day will be drained out through said drain pore 21 which keeps the dry of sand 2, if the sand 2 is polluted and requires to be replaced with a new one, said sand-leaking vent 2 could be opened to drain out the sand 2 naturally, next to replace the new sand 2; a hot gas channel 14, which is interconnected with said container 13 and is covered with said sand 2, by means of said hot gas channel 14 covered by the sand 2 could avoid the dissipation of the heat while maintain its high temperature, and there connects and settles a plurality of empty site 141 above said hot gas channel 14; a collecting casket 15, which is settled within the casket chamber 16 on the bottom of said container 13 which is used to collect the ash of charcoal 41; a storage chamber 17, which is sited below said casket chamber 16 and could allocate some cabobs commodities within; a plurality of rolling wheels 18, which is settled on the bottom of said means of utilizing the heat source with efficiency 1 and could make said means of utilizing the heat source with efficiency 1 moving freely. Among which, there places a charcoal fire 41 on top of the supporting plate 12, and there heats another food 51 above said upper cap 11 so that the means of utilizing the heat source with efficiency 1 has the effects of fish-cooking and fried dish. Wherein the heat gas of said charcoal fire 41 could be transferred onto empty site 141 through the hot gas channel 14 which keeps warm of the warm-keeping drinks inside said cup body 142 through the hot gas channel 14. In addition, since the height of said casket chamber 16 is higher than said collecting casket 15, when said collecting casket 15 is inserted into said casket chamber 16, there forms a vacant 161 between the above portion of said collecting casket 15 and the casket chamber 16 on bottom of the container 13 so that part of the hot gas of the charcoal fire 41 will be dissipated out from said vacant 161, when there is a cold weather or at winter, it is convenient for the users to keep warm. Through this, it will makes the means of utilizing the heat source with efficiency 1 keeps the temperature of the warm-keeping drinks as well as has the effect of being convenient with the users for warming oneself by the fire at the same time of cabobs.

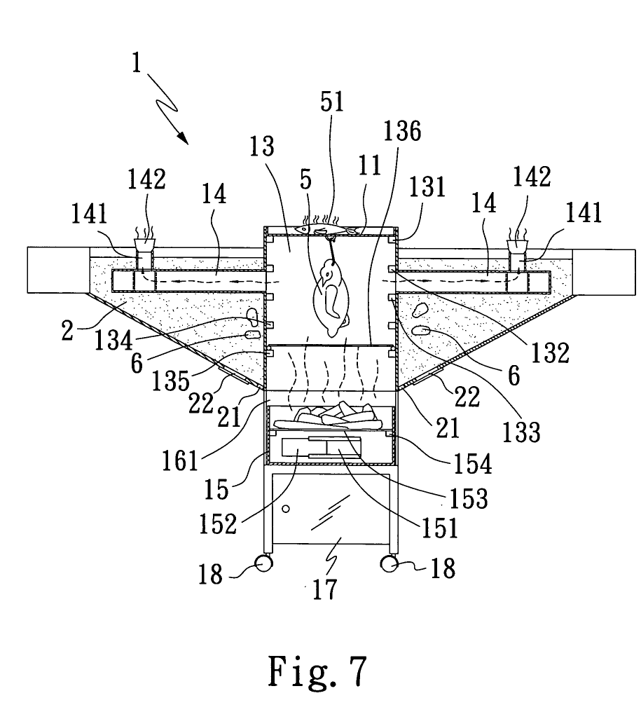

Please refer to FIG. 7, which is another cross-sectional view of the means of utilizing the heat source with efficiency of this invention, as illustrated in the figure:

Said means of utilizing the heat source with efficiency 1 at least comprises: a container 13, which is settled at the center of said means 1, there settles a first convex rib 131, a second convex rib 132, a third convex rib 133, a fourth convex rib 134, and a fifth convex rib 135 inside said container 13, and inversely place an upper cap 11 above said first convex rib 131, and to place a supporting plate 12 above said fourth convex rib 134; a sand 2, which is settled inside said means 1 and outside said container 13, and there settles a plurality of drain pore 21 and a plurality of sand-leaking vent 22 on the neighboring of the sand 2 and on the contacting portion of said means 1, if they were placed outdoors, the rainwater falling on the sand 2 at rainy day will be drained out through said drain pore 21 which keeps the dry of sand 2, if the sand 2 is polluted and requires to be replaced with a new one, said sand-leaking vent 2 could be opened to drain out the sand 2 naturally, next to replace the new sand 2; a hot gas channel 14, which is interconnected with said container 13 and is covered with said sand 2, by means of said hot gas channel 14 covered by the sand 2 could avoid the dissipation of the heat while maintain its high temperature, and there connects and settles a plurality of empty site 141 above said hot gas channel 14; and there settles and places a cup body 142 above said empty site 141; a collecting casket 15, which is settled within the casket chamber 16 on the bottom of said container 13 which is used to collect the ash of charcoal 41; a storage chamber 17, which is sited below said casket chamber 16 and could allocate some cabobs commodities within; a plurality of rolling wheels 18, which is settled on the bottom of said means of utilizing the heat source with efficiency 1 and could make said means of utilizing the heat source with efficiency 1 moving freely. Among which, there places a convex rib 154 inside said collecting casket 15, which could support an iron net 153, and there places the charcoal 41 above said iron net 153, which is provided the heat source of cabobs, there hang to settle a food 5 such as chicken toast or duck toast, etc as the usage of baking, and there places a dust-proof mask 136 above said fifth convex rib 135, which avoids the raising of the dust of the charcoal fire 41 and thus pollutes the food 5. Meanwhile another food 51 above said upper cap 11 could be heated such as fish, meat, vegetables, etc, and packages another food 6 such as corn, sweet potatoes, seafood, etc with the aluminum foil paper and places inside said sand 2. Since the sand 2 has the character of high heat-conductivity, the sand is thus heated by means of the heat of the charcoal fire 41 and further cover toast the food 6, which will keep the original taste of the food 6 without burnt; whereas the heat gas of said charcoal fire 41 could be transferred onto empty site 141 through the hot gas channel 14 which keeps warm of the warm-keeping drinks inside said cup body 142 through the hot gas channel 14. In addition, since the height of said casket chamber 16 is higher than said collecting casket 15, when said collecting casket 15 is inserted into said casket chamber 16, there forms a vacant 161 between the above portion of said collecting casket 15 and the casket chamber 16 on bottom of the container 13 so that part of the hot gas of the charcoal fire 41 will be dissipated out from said vacant 161, when there is a cold weather or at winter, it is convenient for the users to warm oneself by the fire. Through this, it will makes the means of utilizing the heat source with efficiency 1 keeps the temperature of the warm-keeping drinks as well as has the effect of being convenient with the users for warm oneself by the fire at the same time of cabobs.

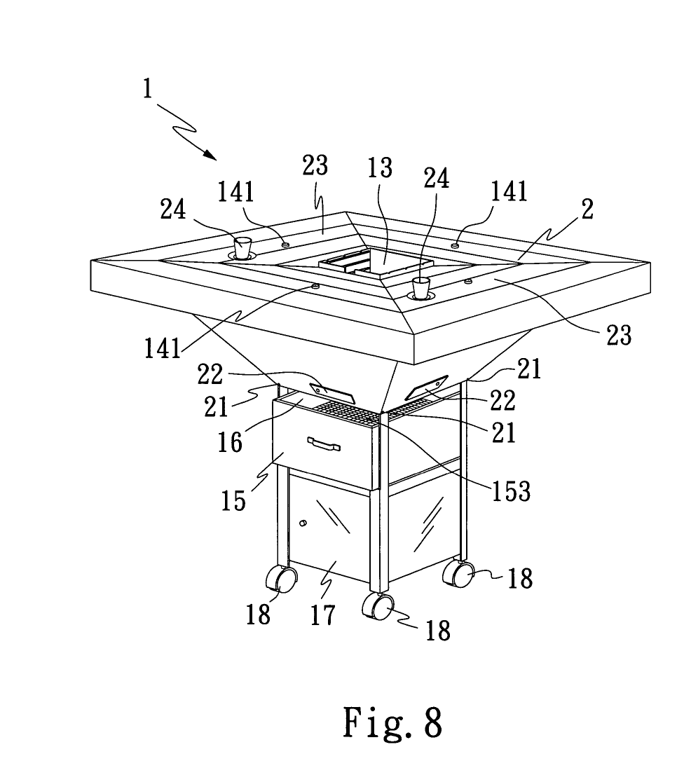

Please refer to FIG. 8, which is another cross-sectional view of the means of utilizing the heat source with efficiency of this invention, as illustrated in the figure:

Said means of utilizing the heat source with efficiency 1 at least comprises:
a container 13, which is settled at the center of said means 1, there settles a first convex rib 131, a second convex rib 132, a third convex rib 133, a fourth convex rib 134, and a fifth convex rib 135 inside said container 13, and inversely place an upper cap 11 above said first convex rib 131, and to place a supporting plate 12 above said fourth convex rib 134; a sand 2, which is settled inside said means 1 and outside said container 13, and there settles a plurality of drain pore 21 and a plurality of
sand-leaking vent 22 on the neighboring of the sand 2 and on the contacting portion of said means 1, if they were placed outdoors, the rainwater falling on the sand 2 at rainy day will be drained out through said drain pore 21 which keeps the dry of sand 2, if the sand 2 is polluted and requires to be replaced with a new one, said sand-leaking vent 2 could be opened to drain out the sand 2 naturally, next to replace the new sand 2; next there could be placed a cap plate 23 above said sand 2; a hot gas channel (not shown in the figure), which is interconnected with said container 13 and is covered with said sand 2, by means of said hot gas channel 14 covered by the sand 2 could avoid the dissipation of the heat while maintain its high temperature, and there connects and settles a plurality of empty site 141 above said hot gas channel 14; and there settles and places a cup body 142 above said empty site 141; a collecting casket 15, which is settled within the casket chamber 16 on the bottom of said container 13 and there settles inside an iron net 153 within; a casket chamber 16, which I settled on the bottom of the container 13, where it could allocate said collecting casket 15; a storage chamber 17, which is sited below said casket chamber 16 and could allocate some cabobs commodities within; a plurality of rolling wheels 18, which is settled on the bottom of said means of utilizing the heat source with efficiency 1 and could make said means of utilizing the heat source with efficiency 1 moving freely. Through the design of the cap plate 23 the area on the top facet of said means of utilizing the heat source with efficiency 1 could be increased, in usage, there could place more article 24 on it for the taking to use by the users.

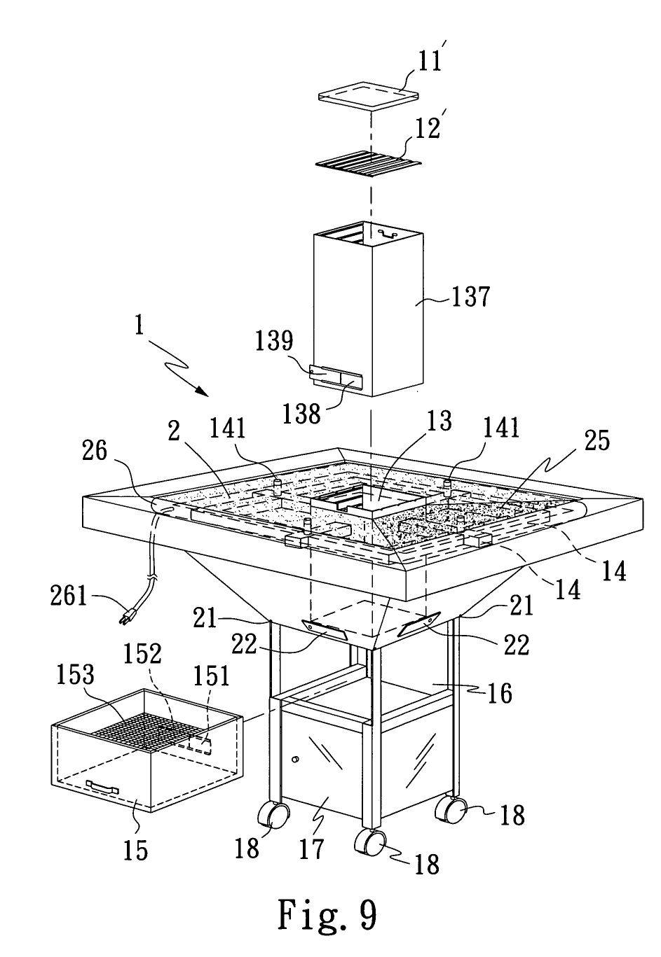

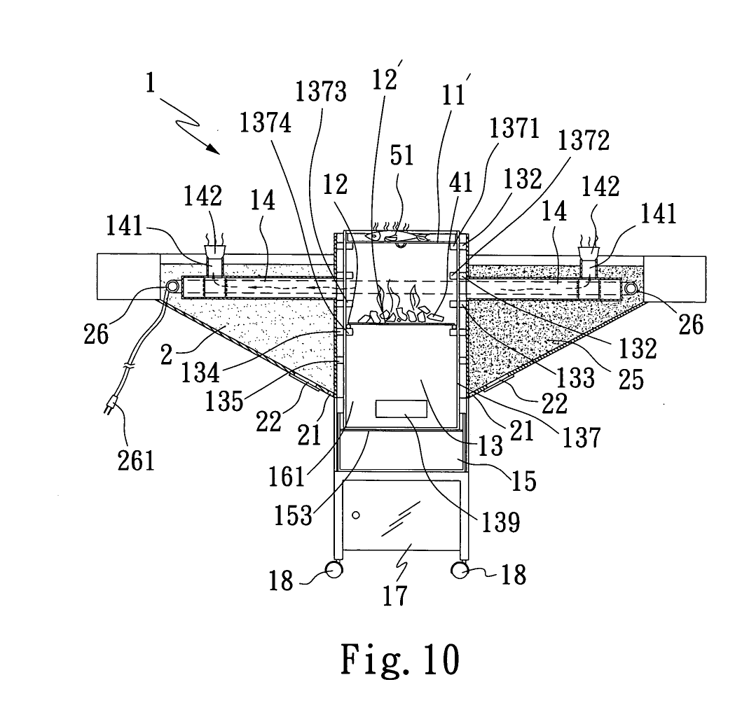

Please refer to FIG. 9, which is the structure decomposition figure of another example of the means of utilizing the heat source with efficiency of this invention; next please refer to FIG. 10, which is the cross-sectional view of this invention, as illustrated in the figure:

Said means of utilizing the heat source with efficiency of this invention at least comprises: a container 13, which is settled at the center of said means 1, there settles a first convex rib 131, a second convex rib 132, a third convex rib 133, a fourth convex rib 134, and a fifth convex rib 135 inside said container 13, and there penetrates to settle a drawer type container 137 in the container 13, wherein inside said drawer type container 137 there settles a first convex rib 1371, second convex rib 1372, third convex rib 1373, fourth convex rib 1374, next there settles a ventilate vent 138 below said drawer type container 137, and there settles a pull door 139 above said ventilate vent 138 to control the amounts of wind; a sand 2, which is settled inside said means 1 and outside said container 13, and there settles a plurality of drain pore 21 and a plurality of sand-leaking vent 22 on the neighboring of the sand 2 and on the contacting portion of said means 1, if they were placed outdoors, the rainwater falling on the sand 2 at rainy day will be drained out through said drain pore 21 which keeps the dry of sand 2, if the sand 2 is polluted and requires to be replaced with a new one, said sand-leaking vent 2 could be opened to drain out the sand 2 naturally, next to replace the new sand 2; next there could be placed a stone region 25 among said sand 2; a hot gas channel 14, which is interconnected with said container 13 and is covered with said sand 2, by means of said hot gas channel 14 covered by the sand 2 could avoid the dissipation of the heat while maintain its high temperature, and there connects and settles a plurality of empty site 141 above said hot gas channel 14; and there settles and places a cup body 142 above said empty site 141; on the peripheral of said hot gas channel 14 there settles an electrical heater tube 26, and there settles a plug 261 on the electrical heater tube, which could be electrically-connected for providing the function of heating; a collecting casket 15, which is settled within the casket chamber 16 on the bottom of said container 13 and there settles inside an iron net 153 within to support said drawer type container 137; a storage chamber 17, which is sited below said casket chamber 16 and could allocate some cabobs commodities within; a plurality of rolling wheels 18, which is settled on the bottom of said means of utilizing the heat source with efficiency 1 and could make said means of utilizing the heat source with efficiency 1 moving freely. When we want to use the means of utilizing the heat source with efficiency 1 of this invention, but worry about the smog will be permeated inside the room on firing, we could first take the drawer type container 137 from the container 13 to outdoors, putting a supporting plate 12 on the fourth convex rib 1374, putting the charcoal fire 41 to firing on said supporting plate 12, while at the end of firing the smog becomes smaller, next to put said drawer type container 137 back the container 13 of said means of utilizing the heat source with efficiency 1, and to put an upper cap 11 inversely on the first convex rib 1371 within said drawer type container 137, which provides the function of frying the food 51. Besides, since there settles a stone region 25 within the sand 2, it could cover toast the smaller or fast-ripen foods such as vegetables, little meats, etc without cover to spoil through the character of rapid heat transfer of the stone and it is easier to evaporate for the heat gas. Besides, the design of the electrical heater tube 26 could enhance the temperature of the hot gas vent 14 rapidly and reduce the waiting time.

The mentioned above is just a preferred embodiment of this invention, which is not meant to limit or confine the claims of this invention; other changes or modifications without departing from the spirit of this invention should be included as the following claims.

1. A means of utilizing the heat source efficiently, at least comprises:
A container, which is settled at the center of said means;
A sand, which is settled inside said means and outside said container;
A heat gas channel, which is interconnected with said container and covered with said sand.

2. The means of utilizing the heat source efficiently as mentioned in claim 1, wherein inside said container there settles a plurality of convex rib.

3. The means of utilizing the heat source efficiently as mentioned in claim 1, wherein there settles an upper cap above said container, and there settles an ear on the facet of said upper cap.

4. The means of utilizing the heat source efficiently as mentioned in claim 1, wherein there settles a dust-proof mask inside said container.

5. The means of utilizing the heat source efficiently as mentioned in claim 1, wherein there settles a casket manger, which could allocate said collecting casket inside, and a storage room, which is sited below said casket manger.

6. The means of utilizing the heat source efficiently as mentioned in claim 1, wherein there settles a plurality of drain pore and a plurality of sand-leaking vent on the neighboring of said sand and the portion where it contacts said means.

7. The means of utilizing the heat source efficiently as mentioned in claim 1, wherein there connects and settles a plurality of empty site above such heat gas channel.

8. The means of utilizing the heat source efficiently as mentioned in claim 1, wherein there penetrates to settle a drawer type container in the container.

9. The means of utilizing the heat source efficiently as mentioned in claim 1, wherein there could be placed a stone region at one specific region.

10. The means of utilizing the heat source efficiently as mentioned in claim 1, wherein at the peripheral of said hot gas channel there settles an electrical heater tube.
